(19) United States
(12) Patent Application Publication
(10) Pub. No.: US 2022/0284285 A1
(43) Pub. Date: Sep. 8, 2022

(54) TRAINING A MACHINE LEARNING-BASED MODEL FOR ACTION RECOGNITION

(71) Applicant: Sony Group Corporation, Tokyo (JP)

(72) Inventor: Sangxia HUANG, Malmö (SE)

(21) Appl. No.: 17/563,812

(22) Filed: Dec. 28, 2021

(30) Foreign Application Priority Data
Mar. 2, 2021 (SE) 2150238-0

(51) Int. Cl. G06N 3/08; G06N 3/04; G06F 17/18

(52) U.S. Cl. CPC G06N 3/08; G06N 3/0454; G06F 17/18

(57) ABSTRACT

A device for training a first machine learning-based model (MLM) for action recognition implements a training method. According to the training method, the training device obtains training data that comprises time sequences of data samples, which represent predefined subjects that are performing predefined actions. The training device trains the first MLM based on the training data, to discriminate between the predefined actions and to be adversarial to discrimination between the predefined subjects by a second MLM, and trains the second MLM based on feature data that is extracted by the first MLM for the training data, to discriminate between the predefined subjects. Thereby, the first MLM is encouraged to extract feature data that is unrelated to individual subjects, which improves action recognition performance of the trained first MLM when encountering new subjects.

### CROSS REFERENCE TO RELATED APPLICATIONS

The present application claims priority to Swedish Application No. 2150238-0 filed Mar. 2, 2021, the content of which is incorporated herein by reference in its entirety.

### TECHNICAL FIELD

The present disclosure relates generally to training of machine learning-based models and, in particular, to such training for action recognition in time-sequences of data samples that represent subjects performing various actions.

### BACKGROUND ART

Action recognition, classification and understanding in videos or other time-resolved reproductions of moving subjects (humans, animals, etc.) form a significant research domain in computer vision. Action recognition, also known as activity recognition, has many applications given the abundance of available moving visual media in today's society, including intelligent search and retrieval, surveillance, sports events analytics, health monitoring, human-computer interaction, etc. At the same time, action recognition is considered one of the most challenging tasks of computer vision.

Machine learning-based models (MLMs) comprising neural networks have shown great promise for use in action recognition systems. One metric for evaluating the accuracy of such action recognition systems is the so-called cross-subject accuracy. The cross-subject accuracy may be evaluated by cross-validation, in which the MLM is first trained on training data collected for a set of subjects, whereupon the trained MLM is then tested on testing data collected for a different set of subjects, and the results are compared. Generally, action recognition systems with neural networks tend to exhibit lower accuracy on testing data than on training data, which indicates that the MLMs overfit to the training data and have poor generalization performance on new subjects. This issue is of great concern for practical deployment because in reality, the training data typically represents only a small number of subjects, whereas the action recognition system with the trained MLM is deployed to operate on data that represents a much larger number of subjects.

One solution would be to collect the training data to represent more diverse subjects. However, this approach requires more data collection and annotation and is thus more costly. Moreover, there may be many different variations between subjects, making it difficult to ensure that all the relevant variations are covered by the subjects in the training data and that no unintentional bias has been introduced during the data collection phase.

### BRIEF SUMMARY

It is an objective to at least partly overcome one or more limitations of the prior art.

Another objective is to improve cross-subject generalization performance in action recognition.

A further objective is to relax the requirement for diversity of the subjects that are represented in the training data to achieve a given cross-subject accuracy.

One or more of these objectives, as well as further objectives that may appear from the description below, are at least partly achieved by a method of training a first machine learning-based model for action recognition according to the independent claims, embodiments thereof being defined by the dependent claims.

Still other objectives, as well as features, aspects and technical effects will appear from the following detailed description, from the attached claims as well as from the drawings.

### BRIEF DESCRIPTION OF DRAWINGS

Embodiments will now be described in more detail with reference to the accompanying schematic drawings.

FIG. 1A shows an example of a time sequence of images and a corresponding time sequence of keypoint groups extracted from the images, and FIG. 1B shows a keypoint group representing a subject.

FIG. 2A shows an example of using a trained machine learning-based model for action recognition, FIG. 2B shows an example of training a machine learning-based model for action recognition, and FIG. 2C shows an example arrangement for subject-adversarial training of a machine learning-based model for action recognition.

FIG. 3 is a flow chart of an example training method.

FIG. 4A is a functional block diagram of example machine learning-based models in the arrangement of FIG. 2C, and FIG. 4B shows example data structures in the arrangement of FIG. 4A.

FIG. 5 is a flow chart of an example training procedure for use in the method of FIG. 3.

FIGS. 6A-6D are graphs of example probability distributions for use in the training procedure of FIG. 5.

FIGS. 7A-7B are graphs of combined data from FIGS. 6A-6D.

FIG. 8 is a flow chart of an example training method.

FIGS. 9A-9B are flow charts of example methods for processing non-categorized deployment data.

FIG. 10 is a block diagram of a machine that may implement any method, procedure, function, or step described herein.

### DETAILED DESCRIPTION OF EXAMPLE EMBODIMENTS

Embodiments will now be described more fully hereinafter with reference to the accompanying drawings, in which some, but not all, embodiments are shown. Indeed, the subject of the present disclosure may be embodied in many different forms and should not be construed as limited to the embodiments set forth herein; rather, these embodiments are provided so that this disclosure may satisfy applicable legal requirements.

Also, it will be understood that, where possible, any of the advantages, features, functions, devices, and/or operational aspects of any of the embodiments described and/or contemplated herein may be included in any of the other embodiments described and/or contemplated herein, and/or vice versa. In addition, where possible, any terms expressed in the singular form herein are meant to also include the plural form and/or vice versa, unless explicitly stated otherwise. As used herein, “at least one” shall mean “one or more” and these phrases are intended to be interchangeable. Accordingly, the terms “a” and/or “an” shall mean “at least one” or “one or more”, even though the phrase “one or more” or “at least one” is also used herein. As used herein, except where the context requires otherwise owing to express language or necessary implication, the word “comprise” or variations such as “comprises” or “comprising” is used in an inclusive sense, that is, to specify the presence of the stated features but not to preclude the presence or addition of further features in various embodiments.

As used herein, the terms “multiple”, “plural” and “plurality” are intended to imply provision of two or more elements. The term “and/or” includes any and all combinations of one or more of the associated elements.

It will furthermore be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing the scope of the present disclosure.

Well-known functions or constructions may not be described in detail for brevity and/or clarity. Unless otherwise defined, all terms (including technical and scientific terms) used herein have the same meaning as commonly understood by one of ordinary skill in the art to which this disclosure belongs.

Like reference signs refer to like elements throughout.

Before describing embodiments in more detail, a few definitions will be given.

As used herein, “machine learning-based model”, abbreviated MLM, refers to a mathematical algorithm which, when implemented on a computer resource, has the ability to automatically learn and improve from experience without being explicitly programmed. The MLM may be based on any suitable architecture, including but not limited to neural networks. The present disclosure relates to so-called supervised or semi-supervised learning algorithms, which are configured to build a mathematical model on training data. The training data comprises a set of training examples. Each training example has one or more inputs and the desired output. The output may be represented by an array or vector, and the inputs may be represented by one or more matrices. Through iterative optimization, by use of the training data, learning algorithms learn a function that is capable of predicting the output associated with new inputs. The resulting mathematical model is thereby trained and is denoted “trained MLM” herein.

As used herein, “neural network” refers to an artificial neural network which is a computational learning system that uses a network of functions to understand and translate a data input of one form into a desired output, usually in another form. The neural network comprises a plurality of interconnected layers of neurons. A neuron is an algorithm that receives inputs and aggregates them to produce an output, for example by applying a respective weight to the inputs, summing the weighted inputs and passing the sum through a non-linear function known as an activation function.

As used herein, “adversarial” has its common meaning in the field of machine learning. A first process that is adversarial to second process will operate to make it difficult for the second process to perform its task. In other words, the first process operates to counteract the purpose of the second process. This may be achieved by the first process generating input data to the second process and tailoring the input data to counteract the purpose of the second process.

As used herein, “loss function” refers to a function that maps an event or values of one or more variables onto a real number representing a “cost” associated with the event. The loss function is also known as “cost function”. Although the present disclosure may refer to minimizing a loss function, this is equivalent to maximizing its negative, sometimes denoted reward function, profit function, utility function, or fitness function. Similarly, maximizing a loss function is equivalent to minimizing its negative.

As used herein, “keypoint” is a reference point that has a predefined placement on a subject. A keypoint is also denoted “feature point” herein. Keypoints may be defined for a specific type of subject, for example a human or animal body, or a part thereof. In the example of human/animal body, keypoints may identify one or more joints and/or extremities and/or other features such as eyes, ears, nose, etc. The spatial location of the keypoint may be given in two or more dimensions. For example, the spatial location may designate a two-dimensional location in an image or a three-dimensional location in a scene.

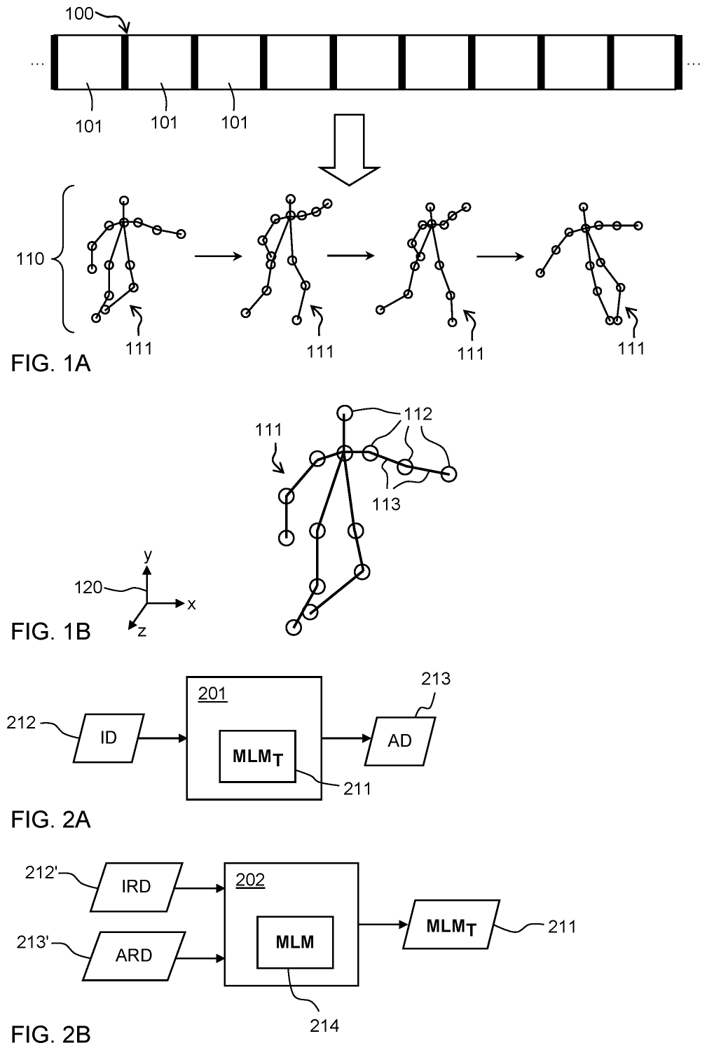

Some embodiments to be described herein below relate to techniques for training a machine learning-based model, MLM, for action recognition. The training and recognition are performed on data consisting of or being extracted from time sequences of images, denoted “image sequences” herein. FIG. 1A schematically depicts an image sequence 100 comprising images 101 associated with consecutive time points. Although not shown, it is assumed that the images 101 depict at least one subject, for example a human or an animal, performing an action or activity. As is well-known in the art, the image sequence 100 may be converted into a corresponding time sequence 110 of keypoint groups 111, as indicated in FIG. 1A. This time sequence 110 is also referred to as a “group sequence” in the following. Each keypoint group 111, also denoted “data sample” herein, comprises a plurality of keypoints 112 (FIG. 1B) that have a predefined placement on the subject. For illustrative purposes, the keypoints 112 may be connected by links 113 (FIG. 1B) to represent an approximate skeleton structure of the subject. The group sequence in FIG. 1A may, for example, be seen to represent an individual that performs the action of shooting a football. If there are plural individuals in a scene, for example in an image sequence 100, the respective individual may be represented by a group sequence performing a respective action. In other words, there will be a separate group sequence for each individual. Keypoint groups of the same individual at different time points may be associated into group sequences in any conventional way, for example by spatial proximity, appearance, etc.

The respective keypoint 112 in a keypoint group 111 is represented by a unique identifier (keypoint identifier), for example a number, and is associated with a respective location in a predefined coordinate system. If the keypoints are extracted from two-dimensional (2D) images, the locations may be given in a predefined 2D coordinate system. If the keypoints are extracted from stereoscopic images, or are otherwise determined from images taken from different view angles onto the subject, the locations may be given in a predefined three-dimensional (3D) coordinate system 120, as shown in FIG. 1B, in the scene of the subject. The following description is applicable to both 2D and 3D location data.

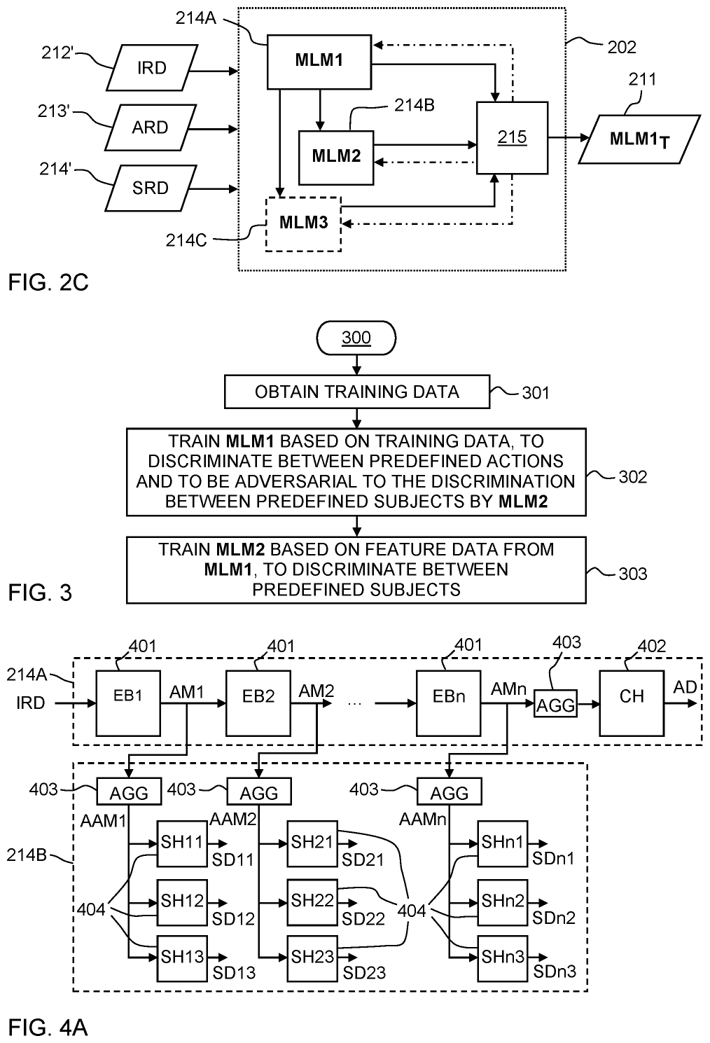

FIG. 2A shows an example installation of a trained MLM, MLM_{T}, 211 for action recognition in an action recognition system 201. The system 201 operates MLM_{T} 211 on input data, ID, 212, which may include an image sequence 100 or a group sequence 110, to generate action data, AD, 213, which is indicative of the action performed by the subject represented by the image sequence 100 or group sequence 110. It is realized that MLM_{T} 211 has been trained to recognize a predefined set of actions, also denoted “action classes” herein. The action classes are dependent on the intended deployment of the system 201. Non-limiting examples include running, jumping, throwing, diving, skiing, kicking, shooting, drinking, sitting, cycling, rowing, swimming, etc.

FIG. 2B illustrates an example training of an MLM 214, which is installed in a training device 202, which may be or comprise any type of computer resource. The training device 202 operates on training data to generate and output MLM_{T} 211. In the illustrated example, the training data comprises labeled input data 212′, also denoted “input reference data” herein, abbreviated IRD. IRD 212′ corresponds to ID 212 but is associated (labeled) with actions. In the following examples, the training data is represented to comprise action reference data 213′, abbreviated ARD, which contains the actions (labels) that are associated with the input data in IRD. Thus, the training data comprises time sequences 100/110 (in IRD) and an action (in ARD) for the respective time sequence 100/110. All actions in ARD 213′ are included among the above-mentioned predefined set of actions, and the respective action may be designated by a unique identifier (action identifier, Action ID), for example a number. As is known in the art, the training involves determining parameter values of MLM 214. MLM_{T} 211 is generated by applying the thus-determined parameter values to MLM 214.

In all examples described in the following, IRD 212′ is assumed to comprise group sequences 110, where each group sequence represents a single subject. By operating on group sequences, i.e. keypoints, instead of image sequences, the amount of data to be processed for training and recognition is significantly reduced. Further, the use of group sequences simplifies the task of restricting each group sequence to represent one subject only. That said, all examples may be adapted for processing of image sequences, as will be readily understood by the skilled person based on the present disclosure.

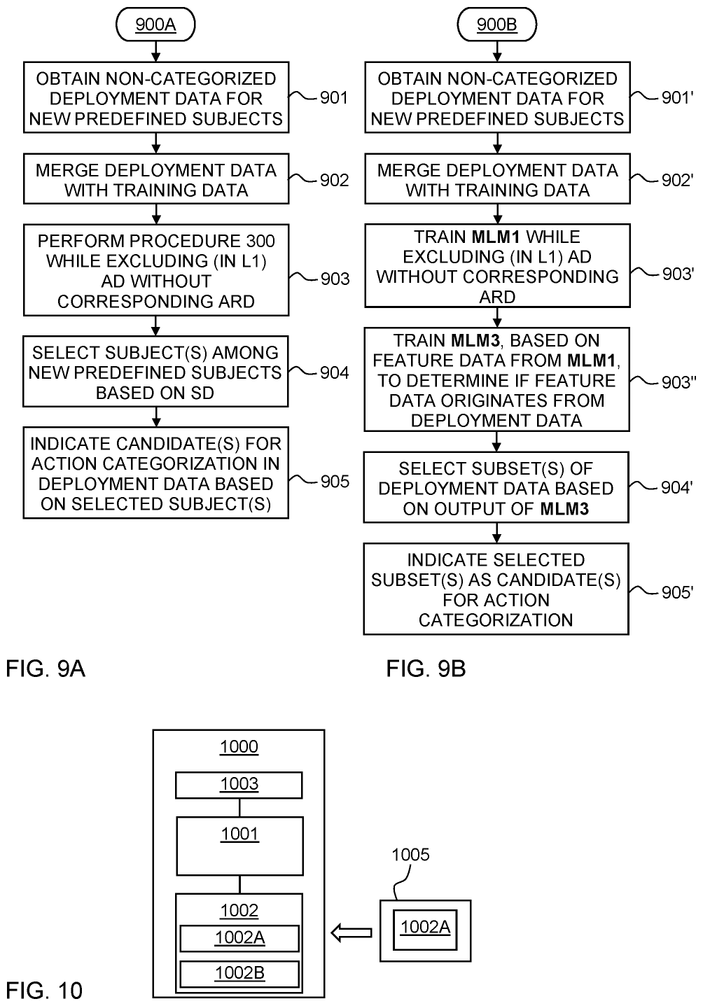

FIG. 2C is a block diagram of an example training device 202 in accordance with some embodiments. The training device 202 is configured to generate and output a trained MLM 211, designated by MLM1_{T}. MLM1_{T} is configured to recognize actions in input data, similar to MLM_{T} in FIG. 2A. The training device 202 comprises a first MLM 214A, designated by MLM1, and a second MLM 214B, designated by MLM2. The training device 202 is configured to perform a training procedure to determine parameter values of MLM1, and generate MLM1_{T} based on the thus-determined parameter values. As shown, MLM2 is arranged to receive data (“feature data”) from MLM1, as will be explained below. The operation of MLM1 and MLM2, and the generation of MLM1_{T} is controlled by a control unit 215 in the training device 202. In FIG. 2C, solid arrows represent transfer of data and dot-dashed arrows represent control signals. The training device 202 is operable to process not only IRD 212′ and ARD 213′, but also subject identity reference data 214′, abbreviated SRD, which is also included in the training data. SRD represents the respective subject in IRD 212′ by a unique identifier (subject identifier, Subject ID), for example a number. The subject identifiers discriminate between different predefined subjects. As understood from the foregoing, the training data includes group sequences 110 (in IRD 212′), an action identifier (in ARD 213′) for the respective group sequence, and a subject identifier (in SRD 214′) for the respective group sequence. As indicated by dashed lines, the training device 202 may also include a third MLM 214C (MLM3), the use and operation of which will be discussed with reference to FIG. 9B.

The training device 202 in FIG. 2C may implement a method that improves cross-subject generalization. The method is based on the insight that when the MLM 214 is trained in FIG. 2B for action recognition, it may be inadvertently trained to associate actions with subjects. This is likely to result in poor performance of the trained MLM, for example in terms of its ability to correctly recognize an action which is performed by another subject than the subject(s) that perform the action in the training data. To alleviate this problem, the MLM to be trained (MLM1) is supplemented by another MLM (MLM2), which is trained to recognize subject identity based on feature data that is extracted by MLM1. On the other hand, MLM1 is trained with the dual objective of recognizing actions and making it difficult for MLM2 to recognize subject identity. In this way, MLM1 is encouraged to extract feature data that is unrelated to each individual subject, hence improving the action recognition performance of the trained MLM1 (MLM1_{T}) when encountering new subjects. The skilled person understands that MLM1 is trained to be adversarial to the discrimination between subjects by MLM2, since MLM1 and MLM2 are trained to optimize for competing objectives, viz. MLM2 is trying to identify subjects, and MLM1 is trying to make subject identification difficult.

FIG. 3 is a flow chart of an example training method 300 in accordance with some embodiments. The training method 300 may be performed by the training device 202 of FIG. 2C and results in MLM1 being trained to recognize actions (cf. MLM1_{T} in FIG. 2C). The method 300 comprises a step 301 of obtaining training data that comprises group sequences, which represent predefined subjects performing predefined actions. The training data may thus correspond to IRD, ARD and SRD in FIG. 2C. Step 302 trains a first MLM based on the training data to discriminate between the predefined actions. In addition, step 302 also trains the first MLM to be adversarial to a discrimination between the predefined subjects by a second MLM. The first MLM corresponds to MLM1 in FIG. 2C, which is trained by step 302 on IRD, ARD and SRD. The second MLM corresponds to MLM2 in FIG. 2. Step 303 trains the second MLM based on feature data, which is extracted by the first MLM from IRD, to discriminate between the predefined subjects. The training of MLM1 and MLM2 may, for example, be performed by conventional backpropagation.

As understood from the foregoing discussion, the example method 300 will improve the cross-subject generalization performance of MLM1_{T} by virtue of the adversarial training of MLM1 in relation to MLM2. Also, with reference to the discussion in the Background section, it is realized that the example method 300 will relax the requirement for diversity of the subjects that are represented in the training data to achieve a given cross-subject accuracy.

It may be noted that in all embodiments and examples described herein, MLM1 may either be completely untrained or be pre-trained by use of any conventional training technique. This merely affects the starting values of the parameters of MLM1 to be optimized by the method 300.

The method 300 is merely an example, and many variations and extensions are conceivable, for example as described further below. It may be noted that step 302 need not be performed before step 303, but step 303 may precede step 302. Further, the training data need not be obtained and processed as a whole by steps 301-303. Instead, steps 301-303 may be repeated for subsets (batches) of the training data, with step 301 obtaining a subset of the training data, and step 302 and/or step 303 performing the respective training based on this subset. Still further, when repeatedly processing subsets, steps 302 and 303 may be interleaved in any way through the repetitions. For example, the method 300 may alternate between step 302 and step 303 between repetitions (batches). In the following description it is presumed that steps 301-303 are performed multiple times, for example for different batches of training data.

It should be noted that machine learning-based models, MLM1 and MLM2, may be implemented by conventional structures or algorithms, using conventional building blocks of MLMs. The desired technical effects are not mainly attributed to the structures or algorithms as such but are achieved by an unconventional combination of MLMs dedicated to different objectives (action recognition and subject identity recognition, respectively) and an unconventional training of the MLMs. In some embodiments, MLM1 is a convolutional neural network, a graph convolutional network, or a temporal convolutional network.

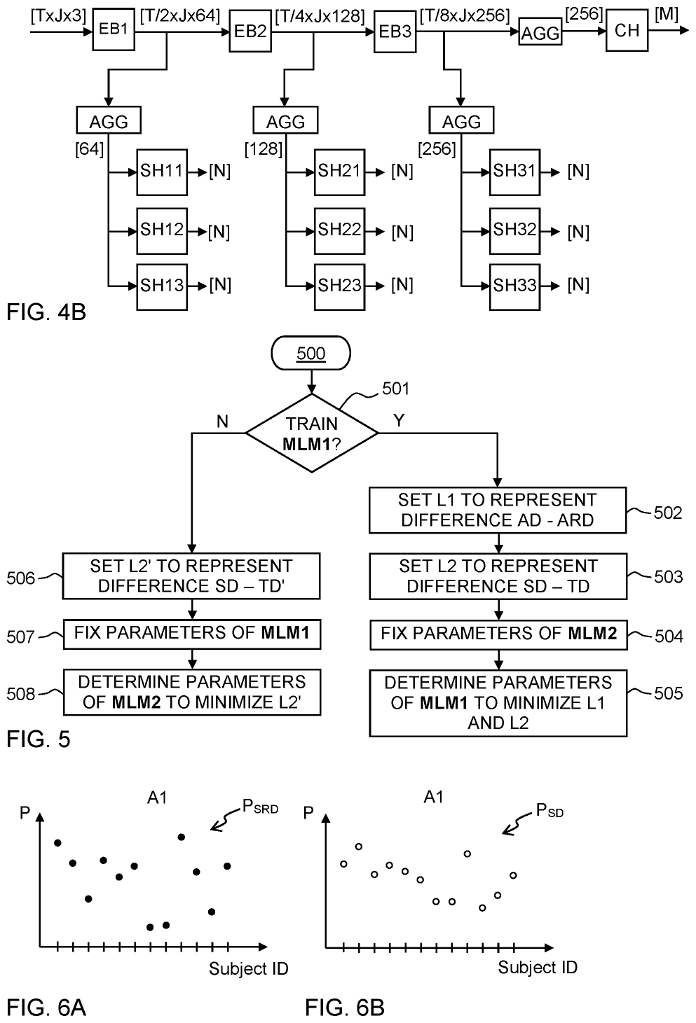

For the sole purpose of providing more context, FIG. 4A shows an example implementation of MLM1 214A and MLM2 214B in the training device 202 of FIG. 2C. In FIG. 4A, MLM1 214A is arranged to receive IRD, which comprises group sequences, and to output action data, AD, which is indicative of an action performed by a subject in the respective group sequence. Further, MLM2 214B is arranged to receive feature data extracted by MLM1 214A and output a set of subject identity data, indicated by SD11, SD12, etc. in FIG. 4A.

In FIG. 4A, MLM1 214A comprises a sequence of so-called encoding blocks 401, which are individually designated by EB1, . . . , EBn. MLM1 214A may include any number of encoding blocks, n≥1. The respective encoding block 401 may be any type of processing layer that is used in artificial neural networks, such a convolutional layer, a pooling layer, a ReLU layer, etc. The output of one encoding block 401 is input for a subsequent encoding block 401, as known in the art. The outputs of the encoding blocks 401 may be denoted “action maps” and are individually designated by AM1, . . . , AMn. The sequence of encoding blocks may be configured to achieve a hierarchical decomposition of IRD, so that the abstraction of extracted features increases for each encoding block 401.

To further illustrate the operation of the encoding blocks 401, reference is made to FIG. 4B which exemplifies data generated in a corresponding structure with three encoding blocks EB1-EB3. Here, it is assumed that a group sequence includes T data samples (keypoint groups), with each data sample having J keypoints, and the location of each keypoint being given by three coordinates. Such a group sequence may be represented by an array (tensor) of size [T×J×3], as indicated in FIG. 4B. The last dimension is conventionally referred to as “channel”. For action recognition, it is common to configure one or more the encoding blocks 401 to aggregate information across time, so that the output contains fewer time steps than the input but has a larger number of channels. For example, in a convolutional layer, the channels may be generated by a respective convolution filter, as is well known in the art. In the example of FIG. 4B, AM1 from EB1 is an array of size [(T/2)×J×64], AM2 from EB2 is an array of size [(T/4)×J×128] and AM3 from EB3 is an array of size [(T/8)×J×256].

Reverting to FIG. 4A, the last action map AMn is passed through an aggregation block 403, designated by AGG, which at least performs a time averaging of AMn to eliminate the time dimension. The aggregation block 403 may also perform an averaging of the second dimension, leaving a vector of the same size as the number of channels in AMn. This is illustrated in FIG. 4B, where AGG converts AMn of size [(T/8)×J×256] to a vector of size [256].

MLM1 214A is concluded by a classification head or layer 402, designated by CH, which processes incoming data to generate the action data, AD. CH may be or comprise a fully connected layer, as is well-known in the art. Although not shown in FIG. 4A, it is realized that CH may be connected to the last encoding block AMn via one or more intermediate blocks or layers. For each group sequence, AD may include an indication of a single predefined action (Action ID), a vector of values describing this action, or a vector of probability values for the different predefined actions (Action IDs). In the latter example, the probability values indicate the likelihood that the group sequence represents the respective predefined action. The following discussion assumes that CH outputs such a distribution of probability values, for example in the form of a vector. An example is given in FIG. 4B, where AD is a vector of size [M], with M being the number of different predefined actions.

In FIG. 4A, MLM2 214B comprises a large number of subject classification heads 404 for subject identity recognition. Since MLM2 is included to enable adversarial training of MLM1, the subject classification heads 404 may be denoted “adversarial heads”. Each adversarial head 404 may be a conventional structure, for example a neural network. In the illustrated example, three adversarial heads 404 are connected to operate on feature data that originates from the respective encoding block 401 in MLM1 214A. These heads 404, which receive the same input data, are configured to recognize subject identity in different ways, for example by differing in network structure, by differing in initialization values, or any combination thereof. It should be understood that the use of plural heads 404 for the same input data is optional but is likely to improve the ability of MLM2 214B to recognize subject identity. Likewise, the use of heads 404 connected to different encoding blocks 401, to receive different input data, is also optional but may be advantageous for the same reason. In a basic embodiment, MLM2 214B has a single adversarial head 404.

For each group sequence, the subject identity data SD11, . . . , SDn3 may be an indication of a single predefined subject (Subject ID), a vector of values describing the subject, or a vector of probability values for the different predefined subjects (Subject IDs). In the latter example, the probability values indicate the likelihood that the group sequence represents the respective predefined subject. The following discussion assumes that each adversarial head 404 outputs such a distribution of probability values, for example in the form of a vector. An example is given in FIG. 4B, where SD11, . . . , SDn3 are vectors of size [N], with N being the number of different predefined subjects.

To simplify the processing by the adversarial heads 404, it has been found beneficial to perform an aggregation or averaging of the respective action map to eliminate at least the time dimension. This aggregation simplifies subject identification training by reducing the size of the input data. Further, it can be assumed that the encoding blocks have aggregated at least some temporal information into the respective action map. It may likewise be beneficial to eliminate the second dimension in the respective action map. To this end, the action maps AM1, . . . , AMn are passed through a respective aggregation block 403, AGG, which output aggregated action maps AAM1, . . . , AAMn. This is illustrated in FIG. 4B, in which the aggregated action maps are vectors of size [64], [128] and [256].

It may be noted that AGG may instead be included in MLM1 214A or be incorporated in the respective adversarial head SH11, . . . , SH3n. Reverting to FIG. 3, it is realized that the feature data that is used by step 303 to train MLM2 may include one or more action maps or one or more aggregated action maps. It is also conceivable the respective action map or aggregated action map is subjected to further intermediate processing before being input to the adversarial head(s) 404.

As understood from the foregoing, in some embodiments, the first MLM comprises a sequence of processing layers 401 and an action classification layer 402, which is directly or indirectly connected to the sequence of processing layers 401, and the feature data used by step 303 is or represents output data of at least one of the processing layers 401. Further, in some embodiments, the method 300 includes a time-averaging of the output data of the at least one of the processing layers 401, and the second MLM is trained based on the time-averaged output data. Still further, in some embodiments, the second MLM is trained based on the output data (time-averaged or not) of two or more processing layers 401 in the sequence of processing layers 401.

FIG. 5 is a flow chart of an example method 500 corresponding to steps 302-303 in FIG. 3. The method 500 may be performed by the control unit 215 in FIG. 2C. Generally, the method 500 operates on action data AD from MLM1 (214A in FIG. 4A), action reference data ARD in the training data (cf. 213′ in FIG. 2C), subject identity data, SD, which is derived from MLM2, and subject identity reference data SRD in the training data (cf. 214′ in FIG. 2C). In some embodiments, the subject identity data SD includes the individual outputs of the adversarial heads 404, i.e. SD11, SDn3 in FIG. 4A. In other embodiments, SD is generated by aggregating the outputs of the adversarial heads 404. For example, if the outputs are vectors of probability values, SD may be generated as a weighted combination, for example an average, of corresponding elements in the vectors.

The example method 500 is repeated at least once and includes a step 501 which decides if MLM1 or MLM2 is to be trained. If MLM1 is to be trained, the method 500 proceeds to step 502, which sets a first loss function L1 to represent the difference between AD and ARD, for example as a difference between probability values in AD and the ground truth according to ARD. L1 may be any conventional loss function, including but not limited to Cross Entropy loss, Mean Absolute Error (MAE) loss, Mean Squared Error (MSE) loss, Logistic loss, Exponential loss, Savage loss, Tangent loss, Hinge loss, Kullback-Leibler loss, etc. Step 503 sets a second loss function L2 to measure how much subject-related information is contained in the feature data extracted by MLM1. Step 504 fixes all parameters of MLM2. These parameters may include weights and biases in the adversarial heads 404 (FIG. 4A), as is well-known to the skilled person. Step 505 operates MLM1 and MLM2 on the training data and determines parameters of MLM1 to minimize both L1 and L2, for example by conventional backpropagation. Step 505 may apply a respective weight to L1 and L2 to set the impact of the respective loss function. The parameters determined by step 505 may include weights and/or biases in the encoding block(s) 401 and/or the action classification head 402 (FIG. 4A). By minimizing L1, MLM1 is trained to recognize actions. By minimizing L2, MLM1 is trained to be adversarial to the recognition of subject identity by MLM2.

If step 501 decides that MLM2 is to be trained, the method 500 proceeds to step 506, which sets a third loss function L2′ to represent how well the subject recognition is performed, for example based on the difference between SD and target data, TD′, given by SRD. The target data TD′ represents the ground truth according to SRD. L2′ may be any conventional loss function, for example as recited above. Step 507 fixes all parameters of MLM1, such as weights and biases in the encoding blocks 401 and the action classification head 402 (FIG. 4A). Step 508 operates MLM1 and MLM2 on the training data and determines parameters of MLM2 to minimize L2′, for example by conventional backpropagation. By minimizing L2′, MLM2 is trained to recognize subjects.

Reverting to step 503, L2 may be set in different ways to quantify the amount of subject-related information in the feature data from MLM1. In this context, “subject-related information” designates content in the feature data that holds any information about the subject that performs the action of the respective group sequence in the training data. In some embodiments, L2 may be set to represent how badly the subject recognition is performed by MLM2. In some embodiments, L2 may be defined to represent the difference between SD and target data, TD, given by SRD. The target data TD used by step 503 may or may not differ from the target data TD′ used by step 506.

In one example, TD is a so-called one-hot vector. A one-hot vector is a vector with one entry for each predefined subject, where all entries are set to zero (0) except the entry that corresponds to the subject in the current group sequence, which entry is set to one (1). One-hot encoding (OHE) is commonly used in classification and is well-known to the skilled person. When TD is such a one-hot vector, L2 may be a negation of any conventional loss function, for example as recited above.

In another example, TD is a probability distribution for different subjects in the training data (“subject reference probability distribution”, or “subject distribution”). The elements of TD thus represent the occurrence rate of the respective predefined subject in the training data. The “occurrence rate” is synonymous with “fractional occurrence” and represents the number of occurrences of a subject in relation to the total number of data samples. When TD is a subject distribution, L2 may be defined to operate on the difference between SD and TD. The difference may be given by any suitable metric, including but not limited to KL divergence, L1 norm, etc. Minimization of L2 may involve minimizing an aggregation of such differences for the training data, or a subset thereof.

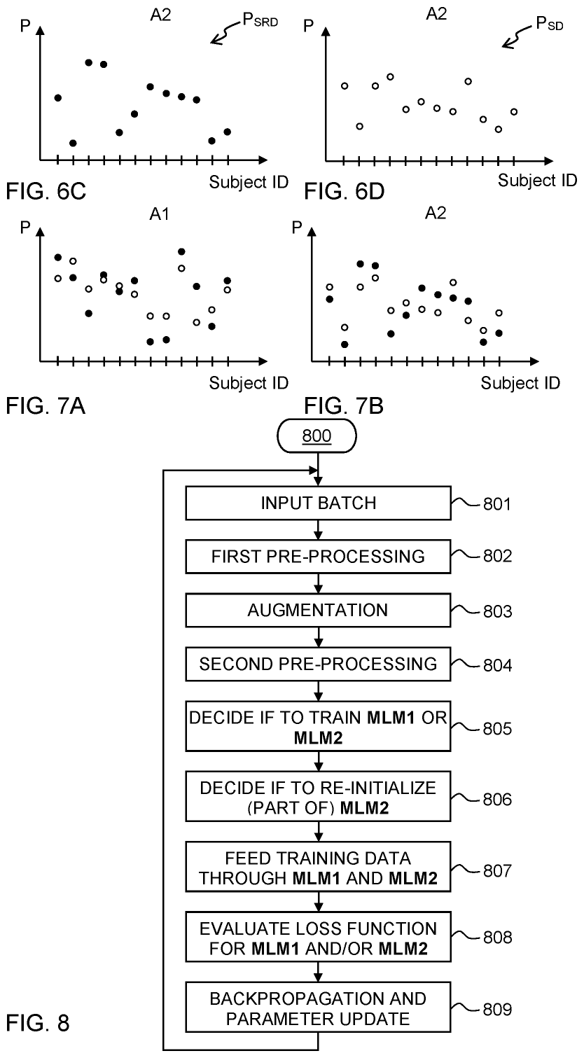

In yet another example, TD is a subject-per-action probability distribution (“subject-action reference distribution”, or “SA distribution”), which has been found to result in a significant improvement of the performance of the trained MLM1. The SA distribution represents the occurrence rate of the different predefined subjects in the training data for each predefined action. Thus, the “occurrence rate” represents the number of occurrences of a subject performing the predefined action in relation to the total number of subjects that perform this predefined action. FIG. 6A is a graph of an SA distribution, P_{SRD}, that represents the occurrence rate of the different predefined subjects (represented by Subject ID) that perform action A1 in the training data. FIG. 6C is a corresponding graph in which P_{SRD} represents the occurrence rate of the different predefined subjects that perform action A2 in the training data. FIGS. 6B and 6D are probability distributions, P_{SD}, for action A1 and action A2, respectively, generated during training of MLM1 and MLM2. The probability distribution P_{SD} corresponds to the above-mentioned SD. FIG. 6B is generated for group sequences known to perform action A1, and FIG. 6D is generated for group sequences known to perform action A2. FIG. 7A shows a combination of the values in FIGS. 6A and 6B, and FIG. 7B shows a combination of the values in FIGS. 6C and 6D.

A loss function L2 that is based on subject-action reference distributions is denoted “subject-action distribution matching” (SADM) loss function hereinafter. The SADM loss function may be defined to operate on the distribution difference between SD (for example, P_{SD} in FIG. 6B or FIG. 6D) that is generated for a group sequence associated with a predefined action, and TD (for example, P_{SRD} in FIG. 6A or FIG. 6C) for this predefined action. In each of FIGS. 7A-7B, the distribution difference may be given as an aggregation of the differences between open and filled dots. The distribution difference may be given by any suitable metric, including but not limited to KL divergence, L1 norm, etc. Minimization of the SADM loss function may involve minimizing an aggregation of such differences for the training data or a batch. For example, the second loss function L2 may operate on an aggregation of differences between corresponding probability values in all pairs of Psi and P_{SRD}, i.e. for all group sequences. If there are multiple adversarial heads (cf. SH11, SH12, etc. in FIG. 4A), L2 may be applied to SD from each adversarial head (cf. SD11, SD12, etc. in FIG. 4A) and then aggregated, for example by a weighted sum.

Thus, in some embodiments, the training of MLM1 results, for a respective group sequence associated with a predefined action, in a probability distribution Psi over the predefined subjects, and the second loss function L2 operates on pairs of probability distributions Psi and reference distributions P_{SRD} associated with the same predefined action, where the reference distributions P_{SRD} represent fractional occurrences of the predefined subjects in the training data for a respective predefined action.

The use and minimization of the SADM loss function L2 may be motivated as follows. The encoding blocks 401 of MLM1 are supposed to produce outputs that are relevant for action recognition. In other words, these outputs (AM1, . . . , AMn in FIG. 4A) carry information about the actual action. The present applicant has realized that this information may also reveal information about subject identity. For example, if the training data includes 10 different subject identities, but only subject identity S1 and subject identity S2 perform action A1 and in equal proportions, then just by knowing that a group sequence represents action A1, the probability that the subject is S1 or S2 is 50%. On the other hand, if the action is not known, the probability that the subject is S1 or S2 is 10%. Moreover, as long as AM1, . . . , AMn contain information about the actual action, it would potentially allow the adversarial heads to predict subject identity better than 10% each for S1 and S2. The use of conventional loss functions for adversarial training results in a uniform subject prediction, which means that AM1, . . . , AMn need to contain less information about the actual action. This might lead to reduced accuracy for action recognition. SADM avoids this problem by setting the target to be a distribution anyone with perfect knowledge of the action class can produce.

In the context of training MLM1 by use of the SADM loss function, it should be noted that TD is selected based on action and not at all based on subject identity. This means that by minimizing the SADM loss function, and thereby bringing the probability distributions generated by MLM2 close to TD for the respective action, MLM2 will be unable to identify subjects based on the output of the encoding blocks in MLM1. Consider an example in which the training data represents all subjects performing all actions the same number of times. For such training data, all TDs for the different actions will be uniform over all subjects, and the SADM loss function measures how close the predicted distribution is to a uniform distribution. Minimizing the SADM loss function will thus minimize or eliminate the ability of MLM2 to identify subjects based on the output(s) of MLM1. It is realized that the same reasoning is equally valid when the training data results in non-uniform TDs, so that minimizing the SADM loss function will result in the desired adversarial training.

In the foregoing examples, it is assumed that the second and third loss functions L2, L2′ operate on probability values for all predefined subjects. However, any one of these loss functions may operate on a subset of these probability values.

FIG. 8 is a flow chart of an example method 800 to illustrate further implementation features of the method 300 in FIG. 3. The method 800 operates on subsets (“batches”) of the training data and is repeated until the training data has been processed at least once by MLM1 and MLM2. The method 800 may be performed by the control unit 215 in FIG. 2C. Step 801 inputs a batch. Each batch comprises group sequences, a predefined action for each group sequence, and a predefined subject for each group sequence. Step 802 performs a first pre-processing of the group sequences in the batch, for example one or more of normalization, filtering, noise removal, etc., as is well-known and conventional in the art. Step 803 performs an augmentation of the group sequences according to any known technique for augmentation of time-series data, such as dropout, addition of perturbations, temporal resampling, etc. Step 804 may perform a second pre-processing of the group sequences, for example to extract new features. Step 805 decides if to train MLM1 or MLM2, based on any suitable logic. Step 806 decides if to re-initialize MLM2 or part thereof, for example a subset of the adversarial heads 404. If so, step 806 performs such re-initialization. Step 807 feeds the group sequences from the batch, as processed by 802-804, through MLM1 and MLM2. Step 808 evaluates the relevant loss function(s). If step 804 has decided to train MLM2, the third loss function L2′ is used as loss function. If step 804 has decided to train MLM1, a combination of the first and second loss functions L1, L2 is used as loss function. Step 808 back propagates the loss and updates the parameters of the model being trained, while keeping the parameters of the other model fixed (cf. steps 504-505 and 507-508 in FIG. 5).

By training only one of MLM1 and MLM2 in each repetition of steps 801-809, the backpropagation is simplified. However, it is conceivable that step 805 is omitted and that both MLM1 and MLM2 are trained in the same repetition.

The training method as described hereinabove may also be used after deployment, for example when MLM1_{T} has been generated and implemented in an action recognition system (cf. 201 in FIG. 2A).

In some embodiments, the training device 202 with MLM1 and MLM2 as shown in FIG. 2C is operated on non-categorized deployment data for the purpose of identifying group sequences in the deployment data that are suitable to be labeled by action, for use in training to further improve MLM1. In this context, “non-categorized” implies that the group sequences in the deployment data are not labeled by action.

FIG. 9A is a flow chart of an example method 900A that uses MLM1 and MLM2 in a training device to identify candidates for action labeling. Step 901 obtains deployment data comprising group sequences that represent new subjects compared to the subjects in the original training data that was used to generate MLM1_{T}. These new subjects have been given unique subject identifiers and are “new predefined subjects”. Thus, the deployment data comprises group sequences and associated subject identifiers. The group sequences in the deployment data, or part thereof, may but need not represent actions that were not represented in the original training data. Step 902 merges the deployment data with the original training data or part thereof, to generate “expanded training data”. Step 903 performs method 300 on the expanded training data, while excluding from the first loss function L1 the action data, AD, that is generated by MLM1 for the group sequences in the deployment data. This exclusion is done since these group sequences are not labeled by action. Thus, step 903 trains MLM1 on the expanded training data to discriminate between the predefined actions, trains MLM1 adversarially via L2, and trains MLM2 on the expanded training data to discriminate between the predefined subjects (which also include the new predefined subjects). Step 904 selects one or more subjects among the new predefined subjects based on SD generated by step 903. For example, step 904 may determine, by comparing SD to the ground truth SRD, the subjects that are most correctly recognized in terms of subject identity, and select these subjects. It is thereby more likely that group sequences for which the outputs of the encoding blocks contain more information relevant for subject identification would be selected. Step 905 indicates candidate(s) for action categorization among the group sequences in the deployment data, specifically among the group sequences that are performed by the selected subject(s). Depending on the deployment data, new actions may have to be predefined for the candidate(s).

In another approach to identify group sequences in the deployment data that are suitable to be labeled by action, the training device 202 may be provided with a third MLM, as represented by MLM3 in FIG. 2C, for use together with MLM1, and optionally MLM2. MLM3 is arranged to operate on feature data extracted by MLM1. This feature data may be identical to the feature data used by MLM2 in the examples above. MLM3 includes one or more adversarial heads, corresponding to the adversarial heads 404 in FIG. 4A. However, the respective adversarial head in MLM3 is configured to classify if the feature data originates from the original training data or not. Thus, the respective adversarial head may output a single probability value, which may indicate the likelihood that the feature data originates from the original training data.

FIG. 9B is a flow chart of an example method 900B that uses MLM1 and MLM3 in a training device to identify candidates for action labeling. Steps 901′ and 902′ are identical to steps 901 and 902 in method 900A. Step 903′ trains MLM1 based on the training data to discriminate between the predefined actions by use of the first loss function L1 and a fourth loss function. The fourth loss function may be defined to operate on output data from MLM3 by analogy with the second loss function L2. Thus, MLM1 may be trained to be adversarial to the discrimination by MLM3. During step 903′, like in step 903, AD generated by MLM1 for the group sequences in the deployment data is excluded from the first loss function L1. Step 903″ trains MLM3 based on the feature data extracted by MLM1 for the training data, to determine if the feature data originates from the original training data or not. Step 903″ uses a fifth loss function which may be defined by analogy with the third loss function L2′. It should be understood that steps 903′, 903″ may be repeatedly operated on batches of the training data. Step 904′ selects one or more subjects among the new predefined subjects based on output data generated by MLM3 during step 903′ and/or step 903″. For example, step 904′ may select, based on the output data, one or more group sequences that are not recognized as belonging to the original training data. Step 905 indicates the one or more group sequences as candidate(s) for action categorization.

The structures and methods disclosed herein may be implemented by hardware or a combination of software and hardware. In some embodiments, such hardware comprises one or more software-controlled computer resources. FIG. 10 schematically depicts such a computer resource 1000, which comprises a processing system 1001, computer memory 1002, and a communication interface 1003 for input and/or output of data. The communication interface 1003 may be configured for wired and/or wireless communication, for example to receive the above-mentioned training data and deployment data. The processing system 1001 may, for example, include one or more of a CPU (“Central Processing Unit”), a DSP (“Digital Signal Processor”), a microprocessor, a microcontroller, an ASIC (“Application-Specific Integrated Circuit”), a combination of discrete analog and/or digital components, or some other programmable logical device, such as an FPGA (“Field Programmable Gate Array”). A control program 1002A comprising computer instructions is stored in the memory 1002 and executed by the processing system 1001 to perform any of the methods, procedures, functions, or steps described in the foregoing. As indicated in FIG. 10, the memory 1002 may also store control data 1002B for use by the processing system 1002, for example definition data of MLMs and loss functions, training data or deployment data. The control program 1002A may be supplied to the computer resource 1000 on a computer-readable medium 1005, which may be a tangible (non-transitory) product (e.g. magnetic medium, optical disk, read-only memory, flash memory, etc.) or a propagating signal.

In the following, a set of clauses are recited to summarize some aspects and embodiments of the invention as disclosed in the foregoing.

C1. A method of training a first machine learning-based model, MLM, for action recognition, said method comprising: obtaining (301) training data comprising time sequences of data samples, wherein the time sequences of data samples represent predefined subjects which are performing predefined actions; training (302) the first MLM based on the training data, to discriminate between the predefined actions; and training (303) a second MLM based on feature data that is extracted by the first MLM for the training data, to discriminate between the predefined subjects; wherein the training (302) of the first MLM is performed to be adversarial to the discrimination between the predefined subjects by the second MLM.

C2. The method of C1, wherein the training (302) of the first MLM comprises: determining parameter values of the first MLM that minimizes a first loss function (L1) that represents a difference between action data (AD) generated by the first MLM and action reference data (ARD), which is predefined and associated with the training data, and that minimizes a second loss function (L2) that represents how much subject-related information is contained in the feature data.

C3. The method of C2, wherein all parameter values of the second MLM are fixed during the training (302) of the first MLM.

C4. The method of C2 or C3, wherein all parameter values of the first MLM are fixed during the training (303) of the second MLM.

C5. The method of any preceding clause, wherein the second loss function (L2) represents a difference between subject identity data (SD) generated by the second MLM and target data (TD), which is predefined and associated with the training data.

C6. The method of C5, wherein the training (303) of the second MLM comprises determining parameter values of the second MLM that minimizes a third loss function (L2′) that represents a difference between the subject identity data (SD) generated by the second MLM and further target data (TD′), which is predefined and associated with the training data.

C7. The method of C6, wherein the second loss function (L2) is a negation of the third loss function (L2′).

C8. The method of any one of C5-C7, wherein the training (302) of the first MLM results in a probability distribution (PSD) over the predefined subjects, and wherein the target data (TD) comprises a reference probability distribution (PSRD) that represents fractional occurrences of the predefined subjects in the training data, and wherein the second loss function (L2) operates on the probability distribution and the reference probability distribution.

C9. The method of any one of C5-C8, wherein the training (302) of the first MLM, for a time sequence associated with a predefined action, results in a probability distribution (PSD) over the predefined subjects, wherein the target data (TD) comprises a reference probability distribution (PSRD) that represents fractional occurrences of the predefined subjects in the training data for each predefined action, wherein the second loss function (L2) operates on a difference between the probability distribution (PSD) and a corresponding reference probability distribution (PSRD), wherein the corresponding reference probability distribution (PSRD) is associated with the predefined action.

C10. The method of C9, wherein the second loss function (L2) aggregates, for the time sequences, differences between the probability distribution (PSD) generated for each time sequence and the corresponding reference probability distribution (PSRD).

C11. The method of any one of C2-C10, wherein the subject identity data (SD) comprises a second probability value for at least one of the predefined subjects, and wherein the second loss function (L2) operates on the second probability value.

C12. The method of any one of C2-C11, further comprising: obtaining (901) deployment data comprising additional time sequences of data samples, wherein the additional time sequences represent additional predefined subjects performing non-categorized actions, and wherein the additional predefined subjects are included among the predefined subjects; including (902) the deployment data in the training data; training (903) the first MLM on at least part of the training data, to discriminate between the predefined actions, while excluding from the first loss function (L1) the action data (AD) that is generated by the first MLM for the additional time sequences; training (903) the second MLM based on feature data extracted by the first MLM for said at least part of the training data, to discriminate between the predefined subjects; and evaluating (904, 905) the subject identity data (SD) and/or the action data (AD) generated by the training (903) of the first MLM and the second MLM.

C13. The method of C12, wherein said evaluating comprises: determining (904), based on the subject identity data (SD) generated by the second MLM, at least one selected subject among the additional predefined subjects; and indicating (905) at least one of the additional group sequences that is performed by said at least one selected subject as a candidate to be categorized by action.

C14. The method of any one of C2-C11, further comprising: obtaining (901′) deployment data comprising additional time sequences of data samples, wherein the additional time sequences represent additional predefined subjects performing non-categorized actions; including (902′) the deployment data in the training data; training (903′) the first MLM based on at least part of the training data, to discriminate between the predefined actions, while excluding from the first loss function (L1) the action data (AD) that is generated by the first MLM for the additional time sequences; training (903″) a third MLM based on feature data extracted by the first MLM for said at least part of the training data, to determine if the feature data originates from the deployment data; and evaluating (904′, 905′) output data generated by the third MLM during the training of the first MLM and/or the third MLM.

C15. The method of C14, wherein the training (903′) of the first MLM is performed to be adversarial to the determination by the third MLM.

C16. The method of C14 or C15, wherein said evaluating (904′, 905′) comprises: determining (904′), based on the output data generated by the third MLM, at least one of the additional time sequences; and indicating (905′) the at least one of the additional time sequences as a candidate to be categorized by action.

C17. The method of any preceding clause, wherein the first MLM comprises a sequence of processing layers (401) and an action classification layer (402), which is directly or indirectly connected to the sequence of processing layers (401), wherein said feature data represents output data of at least one of the processing layers (401).

C18. The method of C17, wherein one or more of the processing layers (401) is a convolutional layer.

C19. The method of C17 or C18, further comprising time-averaging the output data of said at least one of the processing layers (401), wherein the second MLM is trained based on the time-averaged output data.

C20. The method of any one of C17-C19, wherein the second MLM is trained based on the output data of two or more processing layers (401) in the sequence of processing layers (401).

C21. The method of any preceding clause, wherein the second MLM comprises a plurality of subject classification networks (404) which are operable in parallel, and wherein the subject classification networks (404) differ by one of more of initialization values, network structure, or input data.

C22. The method of any preceding clause, wherein the first MLM is a convolutional neural network, a graph convolutional network, or a temporal convolutional network.

C23. The method of any preceding clause, wherein each of the data samples comprises location data of predefined feature points (112) on a subject, the location data being given in a predefined coordinate system (120) of at least two dimensions.

C24. A computer-readable medium comprising computer instructions (1002A) which, when executed by a processing system (1001), cause the processing system (1001) to perform the method of any preceding clause.

C25. A device for training a first machine learning-based model, MLM, for action recognition, said device being configured to perform the method of any one of C1-C23.

What is claimed is:

1. A method of training a first machine learning-based model (MLM) for action recognition, said method comprising: obtaining training data comprising time sequences of data samples, wherein the time sequences of data samples represent predefined subjects which are performing predefined actions; training the first MLM based on the training data, to discriminate between the predefined actions; and training a second MLM based on feature data that is extracted by the first MLM for the training data, to discriminate between the predefined subjects; wherein the training of the first MLM is performed to be adversarial to the discrimination between the predefined subjects by the second MLM,
wherein the training of the first MLM comprises: determining parameter values of the first MLM that minimizes a first loss function that represents a difference between action data generated by the first MLM and action reference data, which is predefined and associated with the training data, and that minimizes a second loss function that represents how much subject-related information is contained in the feature data.

2. The method of claim 1, wherein all parameter values of the second MLM are fixed during the training of the first MLM.

3. The method of claim 2, wherein all parameter values of the first MLM are fixed during the training of the second MLM.

4. The method of claim 2, wherein the second loss function represents a difference between subject identity data generated by the second MLM and target data, which is predefined and associated with the training data.

5. The method of claim 4, wherein the training of the second MLM comprises determining parameter values of the second MLM that minimizes a third loss function that represents a difference between the subject identity data generated by the second MLM and further target data, which is predefined and associated with the training data.

6. The method of claim 5, wherein the second loss function is a negation of the third loss function.

7. The method of claim 4, wherein the training of the first MLM results in a probability distribution over the predefined subjects, and wherein the target data comprises a reference probability distribution that represents fractional occurrences of the predefined subjects in the training data, and wherein the second loss function operates on the probability distribution and the reference probability distribution.

8. The method of claim 4, wherein the training of the first MLM, for a time sequence associated with a predefined action, results in a probability distribution over the predefined subjects, wherein the target data comprises a reference probability distribution that represents fractional occurrences of the predefined subjects in the training data for each predefined action, wherein the second loss function operates on a difference between the probability distribution and a corresponding reference probability distribution, wherein the corresponding reference probability distribution is associated with the predefined action.

9. The method of claim 8, wherein the second loss function aggregates, for the time sequences, differences between the probability distribution generated for each time sequence and the corresponding reference probability distribution.

10. The method of claim 1, wherein the subject identity data comprises a second probability value for at least one of the predefined subjects, and wherein the second loss function operates on the second probability value.

11. The method of claim 1, further comprising:
obtaining deployment data comprising additional time sequences of data samples, wherein the additional time sequences represent additional predefined subjects performing non-categorized actions, and wherein the additional predefined subjects are included among the predefined subjects; including the deployment data in the training data; training the first MLM on at least part of the training data, to discriminate between the predefined actions, while excluding from the first loss function the action data that is generated by the first MLM for the additional time sequences; training the second MLM based on feature data extracted by the first MLM for said at least part of the training data, to discriminate between the predefined subjects; and evaluating the subject identity data and/or the action data generated by the training of the first MLM and the second MLM.

12. The method of claim 11, wherein said evaluating comprises: determining, based on the subject identity data generated by the second MLM, at least one selected subject among the additional predefined subjects; and indicating at least one of the additional group sequences that is performed by said at least one selected subject as a candidate to be categorized by action.

13. The method of claim 1, further comprising: obtaining deployment data comprising additional time sequences of data samples, wherein the additional time sequences represent additional predefined subjects performing non-categorized actions; including the deployment data in the training data; training the first MLM based on at least part of the training data, to discriminate between the predefined actions, while excluding from the first loss function the action data that is generated by the first MLM for the additional time sequences; training a third MLM based on feature data extracted by the first MLM for said at least part of the training data, to determine if the feature data originates from the deployment data; and evaluating output data generated by the third MLM during the training of the first MLM and/or the third MLM.

14. The method of claim 13, wherein the training of the first MLM is performed to be adversarial to the determination by the third MLM.

15. The method of claim 13, wherein said evaluating comprises: determining, based on the output data generated by the third MLM, at least one of the additional time sequences; and indicating the at least one of the additional time sequences as a candidate to be categorized by action.

16. The method of claim 1, wherein the first MLM comprises a sequence of processing layers and an action classification layer, which is directly or indirectly connected to the sequence of processing layers, wherein said feature data represents output data of at least one of the processing layers.

17. The method of claim 16, wherein one or more of the processing layers is a convolutional layer.

18. The method of claim 16, further comprising time-averaging the output data of said at least one of the processing layers, wherein the second MLM is trained based on the time-averaged output data.

19. The method of claim 16, wherein the second MLM is trained based on the output data of two or more processing layers in the sequence of processing layers.

20. The method of claim 1, wherein the second MLM comprises a plurality of subject classification networks which are operable in parallel, and wherein the subject classification networks differ by one of more of initialization values, network structure, or input data.
